(19) United States
(12) Patent Application Publication
(10) Pub. No.: US 2016/0325800 A1
(43) Pub. Date: Nov. 10, 2016

(54) METHOD OF MANUFACTURING MAIN BODY OF BICYCLE SADDLE

(71) Applicant: VELO ENTERPRISE CO., LTD., Taichung City (TW)

(72) Inventor: Tsai-Yun YU, TAICHUNG CITY (TW)

(21) Appl. No.: 15/138,348

(22) Filed: Apr. 26, 2016

(30) Foreign Application Priority Data
May 8, 2015 (TW) 104114821

(51) Int. Cl. B62J 1/18; B29C 44/58; B29C 65/70; B29C 65/48; B29C 65/56; B29C 44/12; B29C 53/02

(52) U.S. Cl. CPC B62J 1/18; B29C 44/1228; B29C 44/58; B29C 53/02; B29C 65/48; B29C 65/562; B29C 65/70; B29K 2627/06

(57) ABSTRACT

A method of manufacturing a main body of a bicycle saddle includes the steps of attaching a cover layer to an inner wall of a mold cavity of a forming mold by vacuum suction to make the cover layer have a main area attached to the inner wall and a circumferential area around the main area, heating a base material in the mold cavity to form it into an elastomer and make the main area of the cover layer be combined with and fit the elastomer, combining a bottom shell with the elastomer, and folding back and fixing the circumferential area of the cover layer to a bottom of the bottom shell.

### BACKGROUND OF THE INVENTION

1. Field of the Invention

The present invention relates generally to bicycle saddles and more particularly, to a method of manufacturing a main body of a bicycle saddle.

2. Description of the Related Art

A main body of a conventional bicycle saddle primarily includes an elastomer, a hard bottom shell and a cover layer. The elastomer is made of foam material such as expanded polyurethane (hereinafter referred to as PU), expanded ethylene-vinyl acetate (hereinafter referred to as EVA) or expanded polyethylene (hereinafter referred to as PE) for providing appropriate ability of cushion and support. The bottom shell is mounted to the bottom of the elastomer for supporting the whole main body of the saddle and being connected with a seat post of the bicycle through other elements. The cover layer, which may be made of synthetic plastic leather for example, covers the top and the periphery of the elastomer for contacting the cyclist.

In the traditional method, the disposal of the cover layer is performed after the elastomer is combined with the bottom shell in a way that a manual work is adopted to cover the top of the elastomer with the cover layer, strain the cover layer to fit it to the elastomer, then fold back the circumference of the cover layer to the downside of the bottom shell and fix the circumference of the cover layer to the bottom shell by means of glue or staple gun. However, such method of disposing the cover layer is not only time-consuming, but also liable to make the cover layer strained unevenly so as to cause the cover layer to oblique or unfit the elastomer. In particular, the cover layer made of synthetic plastic leather, which has low elasticity, is more liable to have the aforesaid problem. Besides, as to the main body of the saddle having a complicated shape, such as a main body having a central through hole, the disposal of the cover layer performed by the aforesaid manual work is more difficult.

European Patent No. EP1919683 discloses a bicycle saddle manufacturing method, wherein while the elastomer is formed in a forming mold by foam molding, the cover layer and the bottom shell provided at the periphery thereof with a groove are also disposed in the forming mold, so that the elastomer is formed and combined with the cover layer and the bottom shell at the same time. After the elastomer is completely formed, the part of the circumference of the cover layer, which is not combined with the elastomer, is cut away, and a rim is formed in the groove of the bottom shell by injection molding, so that the rim covers the peripheries of the bottom shell and the elastomer, thereby providing waterproof effect. Although such method of disposing the cover layer is prevented from the aforesaid problem of manual work, the whole manufacturing process is complicated.

US Patent Publication No. 2013/0174971 discloses a bicycle saddle manufacturing method, wherein after the elastomer is combined with the bottom shell, the cover layer is fixed to the elastomer and the bottom shell in an enclosed chamber applying a pneumatic pressure to fit the cover layer to the elastomer. Although such method of disposing the cover layer is prevented from the aforesaid problem of manual work, it makes the saddle manufacturing process complicated.

### SUMMARY OF THE INVENTION

The present invention has been accomplished in view of the above-noted circumstances. It is an objective of the present invention to provide a method of manufacturing a main body of a bicycle saddle, which can prevent the cover layer from being strained unevenly and unfitting the elastomer, prevent the periphery of the main body of the bicycle saddle from unevenness, and simplify the manufacturing process of the main body of the bicycle saddle.

To attain the above objective, the present invention provides a method of manufacturing a main body of a bicycle saddle, which includes the steps of:
a) attaching a cover layer to an inner wall of a mold cavity of a forming mold by vacuum suction in a way that the cover layer has a main area attached to the inner wall of the mold cavity and a circumferential area located around the main area;
b) heating a base material in the mold cavity of the forming mold to form the base material into an elastomer in a way that the main area of the cover layer is combined with the elastomer and fits the elastomer, and combining a bottom shell with the elastomer; and
c) folding back the circumferential area of the cover layer to a bottom of the bottom shell and fixing the circumferential area of the cover layer at the bottom of the bottom shell.

Because the cover layer is attached to the inner wall of the mold cavity before the base material is heated and formed into the elastomer in the mold cavity, the cover layer can fit the elastomer perfectly when being combined with the elastomer, so that the procedures of folding back and fixing the circumferential area of the cover layer in the step c) can be performed easily. In this way, the problem of the manual work adopted in the traditional method of disposing the cover layer, i.e. the problem that the cover layer tends to be strained unevenly, can be avoided. Besides, the circumferential area of the cover layer is folded back to the bottom of the bottom shell and then fixed to the bottom shell, so the peripheries of the elastomer and the bottom shell are completely covered with the cover layer, so that the periphery of the main body of the bicycle saddle is even and smooth. When the main body of the bicycle saddle is in use, the aforesaid feature can avoid or lower the cyclist's uncomfortable feeling resulted from the friction between the crotch of the cyclist and the periphery of the main body of the bicycle saddle. Moreover, the cover layer is combined with the elastomer while the base material is heated and formed into the elastomer, so the manufacturing process of the main body of the bicycle saddle is simplified.

Preferably, the base material used in the step b) may be a liquid foamable material; in the step b), the liquid foamable material is injected into the mold cavity of the forming mold to be expanded and formed into the elastomer on the main area of the cover layer. In this way, the manufacturing process of the main body of the bicycle saddle is further simplified, and the cover layer can fit the elastomer more perfectly.

Preferably, in the step b) the bottom shell may be combined with the elastomer in the forming mold while the base material is heated and formed into the elastomer, so as to further simplify the manufacturing process of the main body of the bicycle saddle. However, in the step b) the bottom shell may be combined with the elastomer after the base material is heated and formed into the elastomer and the elastomer is combined with the cover layer.

Preferably, in the step b) a connection layer may be disposed between the bottom shell and the elastomer. More preferably, the connection layer may be a plastic film, such as PE film, Poly-Vinyl Chloride (hereinafter referred to as PVC) film, and so on. In this way, the connection layer can prevent the base material in the mold cavity from overflowing onto the bottom shell to contaminate the exposed surface at the bottom of the bottom shell, and increase the connecting strength between the bottom shell and the elastomer.

Preferably, the forming mold may include an upper die and a lower die, and the mold cavity is located at the lower die; the base material used in the step b) may be a liquid foamable material; in the step b), the liquid foamable material is injected into the mold cavity, the bottom shell is disposed at the upper die, and then the lower die is covered with the upper die, so that the liquid foamable material is expanded and formed into the elastomer between the bottom shell and the cover layer, and meanwhile the bottom shell and the cover layer are combined with the elastomer in the forming mold. More preferably, in the step b) a connection layer may be disposed at one of the upper die and the lower die before the lower die is covered with the upper die; while the lower die is covered with the upper die, the bottom shell is combined with the elastomer through the connection layer.

Besides, the forming mold may further include a pressing frame; in the step a) the circumferential area of the cover layer is disposed between the pressing frame and the lower die; while the lower die is covered with the upper die, the upper die is pressed on the pressing frame. In the step b), a connection layer may be disposed at one of the upper die and the lower die before the lower die is covered with the upper die; while the lower die is covered with the upper die, the connection layer is disposed between the pressing frame and one of the lower die and the upper die, and the bottom shell is combined with the elastomer through the connection layer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a flow chart of a method of manufacturing a main body of a bicycle saddle according to a first preferred embodiment of the present invention;

FIGS. 2-8 are schematic sectional views showing the process of the method of manufacturing the main body of the bicycle saddle according to the first preferred embodiment of the present invention;

FIG. 9 is a schematic perspective view of the main body of the bicycle saddle according to the first preferred embodiment of the present invention;

FIG. 10 is a flow chart of a method of manufacturing a main body of a bicycle saddle according to a second preferred embodiment of the present invention;

FIG. 11 is similar to FIG. 6, but lacking a bottom shell; and

FIG. 12 is similar to FIG. 6, but having a connection layer additionally.

### DETAILED DESCRIPTION OF THE INVENTION

First of all, it is to be mentioned that same reference numerals used in the following preferred embodiments and the appendix drawings designate same or similar elements throughout the specification for the purpose of concise illustration of the present invention. Besides, when it is mentioned that an element is combined with another element, it means that the former element is directly combined with the latter element, or the former element is indirectly combined with the latter element through one or more other elements between aforesaid former and latter elements.

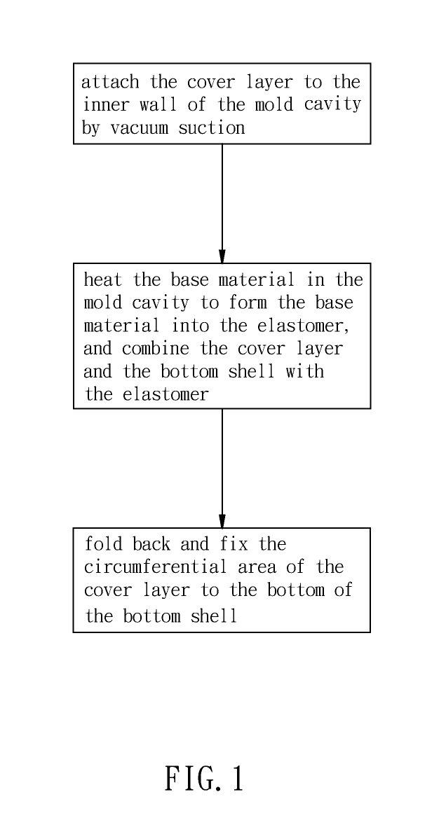

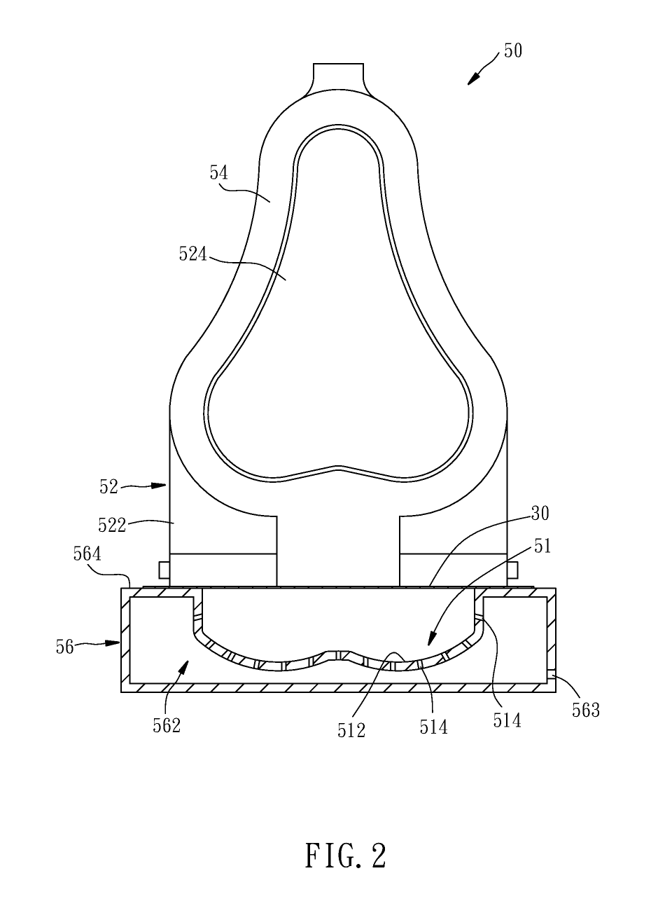

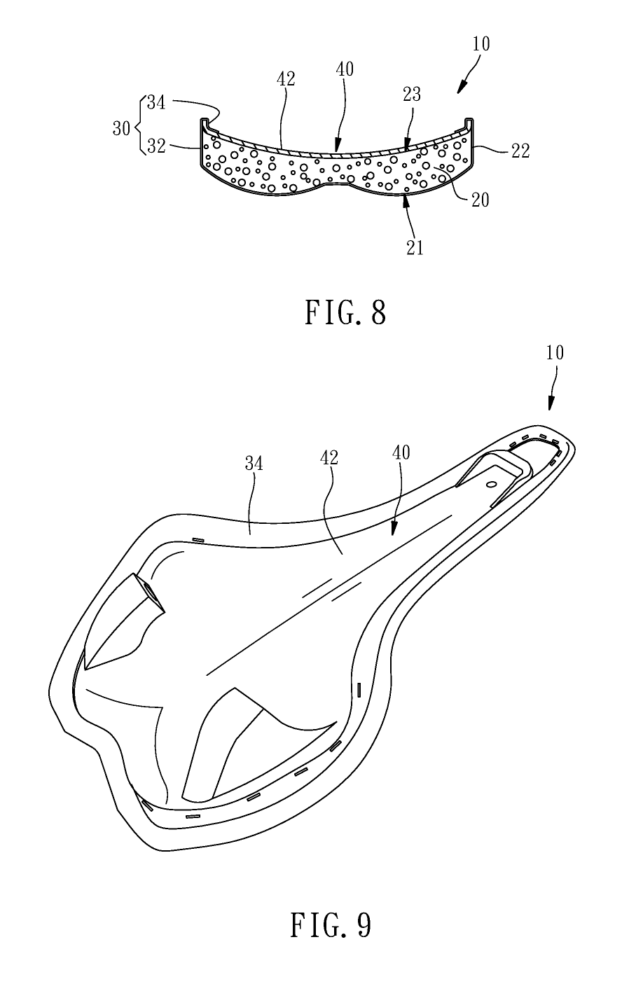

Referring to FIGS. 1-9, a method of manufacturing a main body of a bicycle saddle according to a first preferred embodiment of the present invention is adapted for manufacturing a main body 10 as shown in FIGS. 8-9. The main body 10 of the bicycle saddle includes an elastomer 20, a cover layer 30 and a bottom shell 40. The elastomer 20 is made of foam material, which is usually closed cell foam, such as EVA, PE, or PU, for providing the elastomer 20 ability of cushion and support. However, the material of the elastomer 20 is not limited to the aforesaid materials. In this embodiment, the cover layer 30 is made of a cloth having a smooth surface without any hole/pore, such as synthetic plastic leather. The cover layer 30 covers a top 21 and a periphery 22 of the elastomer 20 for contacting the cyclist. The bottom shell 40 is a hard shell made of plastics and mounted to a bottom 23 of the elastomer 20. The method of manufacturing the main body 10 of the bicycle saddle includes the following steps.
a) As shown in FIGS. 2-4, attach the cover layer 30 to an inner wall 512 of a mold cavity 51 of a forming mold 50 by vacuum suction in a way that the cover layer 30 has a main area 32 attached to the inner wall 512 of the mold cavity 51 and a circumferential area 34 located around the main area 32.

In this embodiment, the forming mold 50 includes an upper die 52, a pressing frame 54 and a lower die 56, which are pivotally connected with each other, and the mold cavity 51 is located at the lower die 56. The upper die 52 has a bottom surface 522, and a protrusion 524 protruded from the bottom surface 522. The internal contour of the pressing frame 54 is approximately the same in shape with the external contour of the protrusion 524. The lower die 56 is a shell provided therein with a space 562 and provided at one side thereof with an air exhausting passage 563 which communicates with the space 562. The mold cavity 51 is concaved from a top surface 564 of the lower die 56 and approximately shaped as the main body 10 of the bicycle saddle. The inner wall 512 of the mold cavity 51 is provided with a plurality of through holes 514 communicating with the space 562.

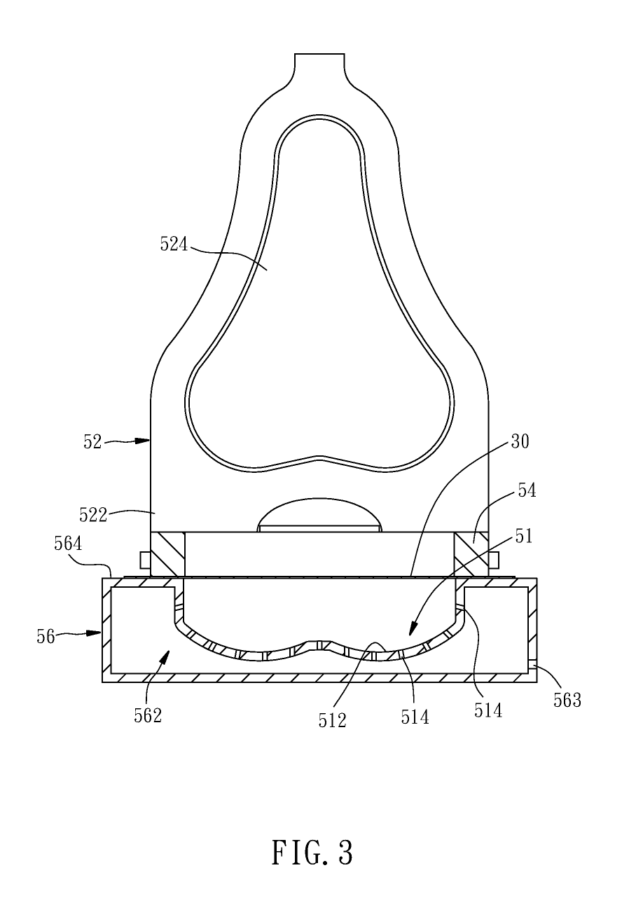

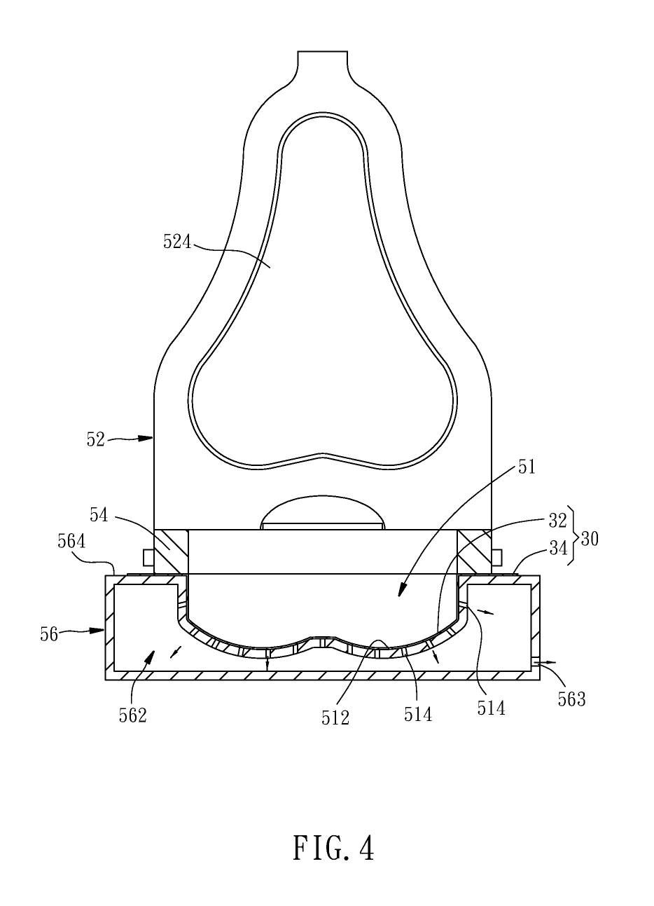

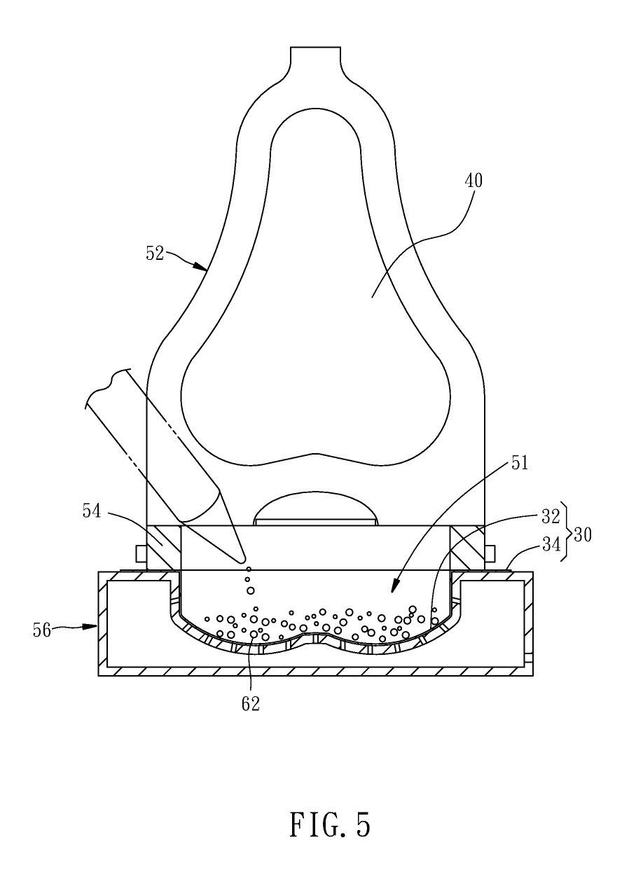

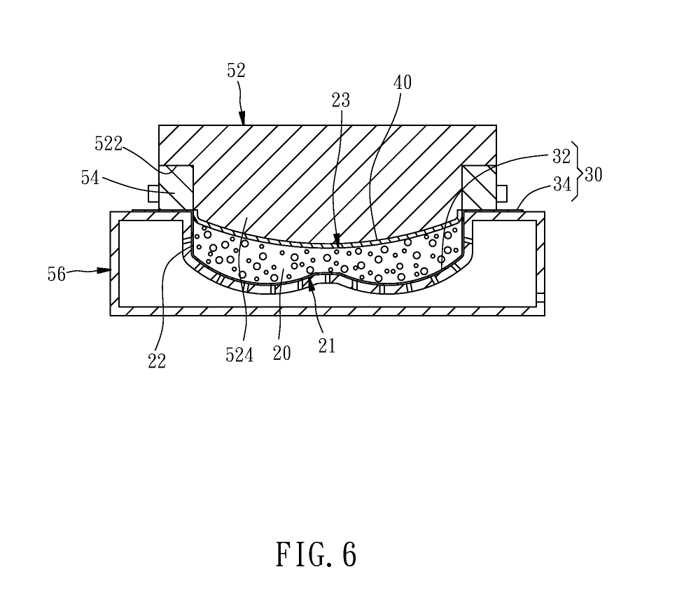

In the step a), the cover layer 30 is placed on the top surface 564 of the lower die 56, and then the pressing frame 54 is pressed on the top surface 564 with the cover layer 30 disposed therebetween, as shown in FIG. 3. The cover layer 30 is tightly attached to the inner wall 512 of the mold cavity 51 by a way that the air in the space 562 and the mold cavity 51 is exhausted through the air exhausting passage 563 to create a vacuum in the space 562. In this way, the cover layer 30 has the main area 32 attached to the inner wall 512 of the mold cavity 51 and the circumferential area 34 located between the pressing frame 54 and the top surface 564, as shown in FIG. 4.
b) As shown in FIGS. 5-6, heat a base material in the mold cavity 51 of the forming mold 50 to form the base material into the elastomer 20 in a way that the main area 32 of the cover layer 30 is combined with the elastomer 20 and fits the elastomer 20, and combine the bottom shell 40 with the bottom 23 of the elastomer 20.

In this embodiment, the base material is a liquid foamable material 62 which is a mixture of a plastic material, a foaming agent and other additive. The plastic material may, but not limited to, be EVA, PE, PU, and so on. When the lower die 56 is not yet covered with the upper die 52 as shown in FIG. 5, the liquid foamable material 62 is injected or poured into the mold cavity 51, and the bottom shell 40 is disposed at the protrusion 524 of the upper die 52. After that, the lower die 56 is covered with the upper die 52 as shown in FIG. 6, so that the mold cavity 51 becomes enclosed. Because the forming mold 50 in this embodiment includes the pressing frame 54 located between the upper die 52 and the lower die 56, the upper die 52 is pressed on the pressing frame 54 while the lower die 56 is covered with the upper die 52. After that, the liquid foamable material 62 in the enclosed mold cavity 51 is heated to be expanded and formed into the elastomer 20 by the forming mold 50. Specifically speaking, the liquid foamable material 62 is expanded and formed into the elastomer 20 between the bottom shell 40 and the main area 32 of the cover layer 30; meanwhile, the main area 32 of the cover layer 30 is combined with the top 21 and the periphery 22 of the elastomer 20, and the bottom shell 40 is combined with the bottom 23 of the elastomer 20.

It will be appreciated that the way of forming the elastomer 20 is not limited to that provided in this embodiment, as long as the elastomer 20 is heated and shaped in the mold cavity 51 and combined with the cover layer 30 at the same time. For example, the base material may be a sheet-shaped or block-shaped foamable material to be put into the mold cavity 51 to be expanded and formed into the elastomer 20 in the step b). Alternately, the base material may be a semi-finished elastomer of the main body of the bicycle saddle, which is preliminarily expanded before the step b), and put into the mold cavity 51 to be secondarily expanded and formed into the elastomer 20 in the step b). Besides, the bottom shell 40 may be coated on a surface thereof with glue before being combined with the elastomer 20, so as to increase the connecting strength between the bottom shell 40 and the elastomer 20.

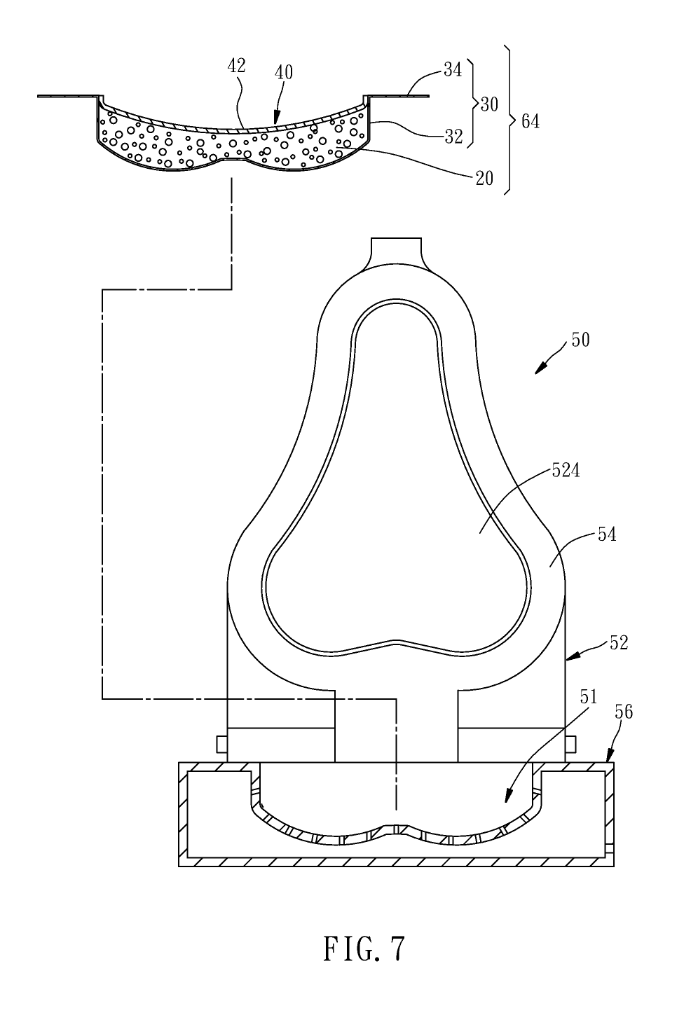

As shown in FIG. 7, after the step b) is accomplished, the semi-finished main body 64 of the bicycle saddle can be taken out of the mold cavity 51 of the forming mold 50 before the following step c) is performed. At this time, the circumferential area 34 of the cover layer 30 is located around the periphery of the bottom 42 of the bottom shell 40.
c) As shown in FIGS. 8-9, fold back the circumferential area 34 of the cover layer 30 to the bottom 42 of the bottom shell 40 and fix the circumferential area 34 of the cover layer 30 at the bottom 42 of the bottom shell 40.

After the aforesaid step b) is accomplished, the manufacture of the main body 10 of the bicycle saddle is almost finished except that a manual work should be adopted to embellish the circumferential area 34 of the cover layer 30, which is the step c). The circumferential area 34 of the cover layer 30 may, but not limited to, be partially cut away to have appropriate size, and then folded back from the periphery 22 of the elastomer 20 to the downside of the bottom 23 of the elastomer 20. In more detail, the circumferential area 34 of the cover layer 30 is folded back to the periphery of the bottom 42 of the bottom shell 40. After that, the circumferential area 34 is fixed at the periphery of the bottom 42 of the bottom shell 40 by means of glue or staple gun, so that the manufacture of the main body 10 of the bicycle saddle is accomplished.

In the method of the present invention, it is easy to fix and fit the cover layer 30 to the elastomer 20 in the step b), so that the procedures of folding back and fixing the circumferential area 34 of the cover layer 30 are easy to be performed. In this way, the problem of the manual work adopted in the traditional method of disposing the cover layer can be avoided, and the manufacturing process of the main body of the bicycle saddle can be simplified. Besides, the peripheries of the elastomer and the bottom shell are completely covered with the cover layer, so the periphery of the main body of the bicycle saddle is even and smooth, which can avoid or lower the cyclist's uncomfortable feeling resulted from the friction between the crotch of the cyclist and the periphery of the main body of the bicycle saddle.

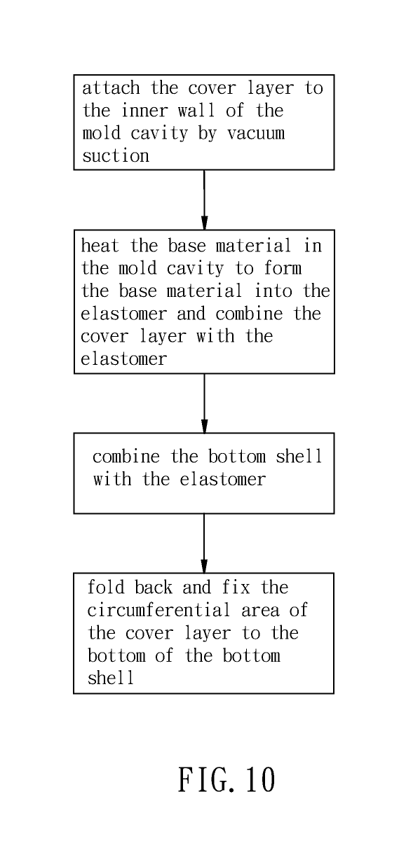

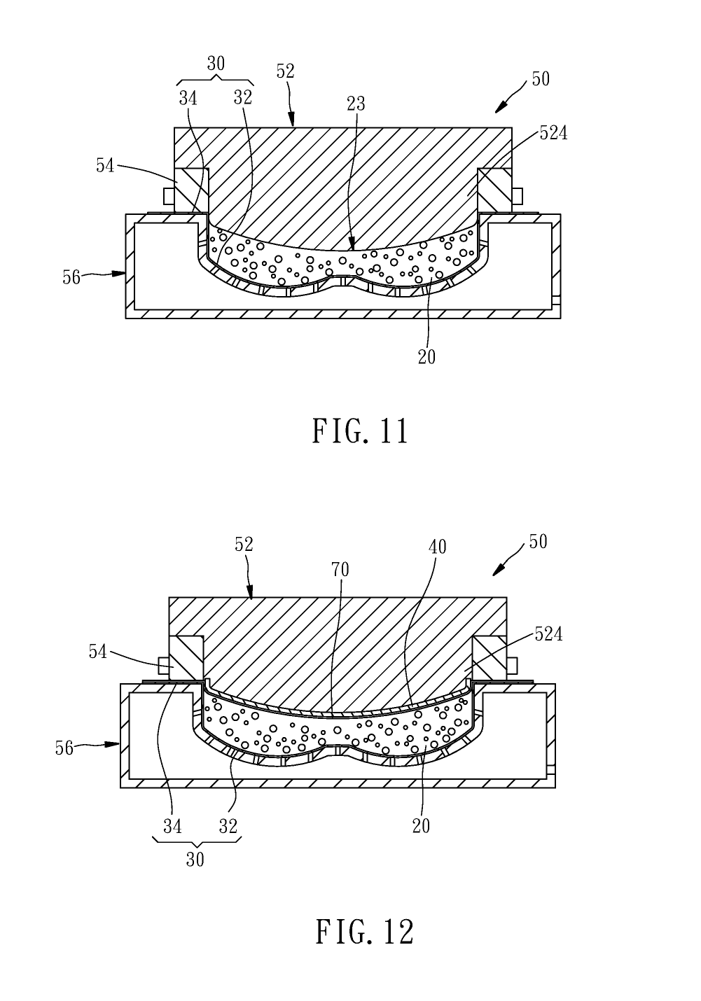

Referring to FIG. 10, the method of manufacturing the main body of the bicycle saddle according to a second preferred embodiment of the present invention is different from the method of the aforesaid embodiment in the step b). In the step b) of the aforesaid embodiment, the bottom shell 40 is combined with the elastomer 20 in the forming mold 50 while the base material is heated and formed into the elastomer 20. However, in the step b) of this embodiment, the base material is heated and formed into the elastomer 20 and meanwhile the elastomer 20 is combined with the cover layer 30; after that, the bottom shell 40 is combined with the elastomer 20. This means, as shown in FIG. 11, while the base material is heated and formed into the elastomer 20, the bottom shell 40 is not disposed in the forming mold 50, and the elastomer 20 is formed between the protrusion 524 of the upper die 52 and the cover layer 30. After that, the combination of the elastomer 20 and the cover layer 30 is taken out of the forming mold 50, and then the bottom shell 40 is mounted to the bottom 23 of the elastomer 20. The aforesaid procedure of combining the bottom shell 40 with the bottom 23 of the elastomer 20 is not limited to be performed by means of the same mold wherein the elastomer 20 is formed, but may use different mold or jig, or use a manual work to glue the bottom shell 40 to the elastomer 20. As to the whole method of manufacturing the main body of the bicycle saddle, the method of the first preferred embodiment is relatively simpler, but the method of this embodiment can still prevent the cover layer from being strained unevenly and unfitting the elastomer and prevent the periphery of the main body of the bicycle saddle from unevenness, and is still simpler than the conventional method of manufacturing the main body of the bicycle saddle.

Referring to FIG. 12, on the condition that the elastomer 20 is formed and combined with the bottom shell 40 at the same time, a connection layer 70 may be disposed between the bottom shell 40 and the elastomer 20 in the step b). The connection layer 70 may, but not limited to, be a plastic film, such as PE film or PVC film. In the embodiment as shown in FIG. 12, before the lower die 56 is covered with the upper die 52, the connection layer 70 is disposed at the lower die 56, located between the pressing frame 54 and the lower die 56, and covers the mold cavity 51. While the lower die 56 is covered with the upper die 52, the bottom shell 40 is combined with the elastomer 20 through the connection layer 70. Alternately, before the lower die 56 is covered with the upper die 52, the connection layer 70 may be disposed at the upper die 52 and covers the protrusion 524; while the lower die 56 is covered with the upper die 52, the connection layer 70 is located between the pressing frame 54 and the upper die 52, and the bottom shell 40 is combined with the elastomer 20 through the connection layer 70. Of course, glue can be applied to increase the connecting strength between the connection layer 70 and the bottom shell 40 and the connecting strength between the connection layer 70 and the elastomer 20.

The connection layer 70 can increase the connecting strength between the bottom shell 40 and the elastomer 20. Besides, if the foamable material 62 in the mold cavity 51 is so much as to overflow when the lower die 56 is covered with the upper die 52, the connection layer 70 can prevent the foamable material 62 from contacting the exposed surface of the bottom shell 40, so as to avoid the follow-up procedure of cleaning the overflowing material.

Besides, the method of the present invention may be applied to manufacture the main body of the bicycle saddle having a hollow portion opened on the top and bottom surfaces of the main body. In such application, the circumferential area 34 of the cover layer 30 mentioned in the step a) of the method of the present invention includes a section corresponding in position to the aforesaid hollow portion, and the section is put through the bottom shell's through hole located at the hollow portion to be folded back and fixed to the bottom of the bottom shell in the step c).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing a main body of a bicycle saddle comprising the steps of:
a) attaching a cover layer to an inner wall of a mold cavity of a forming mold by vacuum suction in a way that the cover layer has a main area attached to the inner wall of the mold cavity and a circumferential area located around the main area;
b) heating a base material in the mold cavity of the forming mold to form the base material into an elastomer in a way that the main area of the cover layer is combined with the elastomer and fits the elastomer, and combining a bottom shell with the elastomer; and
c) folding back the circumferential area of the cover layer to a bottom of the bottom shell and fixing the circumferential area of the cover layer at the bottom of the bottom shell.

2. The method of claim 1, wherein the base material used in the step b) is a liquid foamable material; in the step b), the liquid foamable material is injected into the mold cavity of the forming mold to be expanded and formed into the elastomer on the main area of the cover layer.

3. The method of claim 1, wherein in the step b) the bottom shell is combined with the elastomer in the forming mold while the base material is heated and formed into the elastomer.

4. The method of claim 1, wherein in the step b) the bottom shell is combined with the elastomer after the base material is heated and formed into the elastomer and the elastomer is combined with the cover layer.

5. The method of claim 1, wherein in the step b) a connection layer is disposed between the bottom shell and the elastomer.

6. The method of claim 5, wherein the connection layer is a plastic film.

7. The method of claim 1, wherein the forming mold comprises an upper die and a lower die, and the mold cavity is located at the lower die; the base material used in the step b) is a liquid foamable material; in the step b), the liquid foamable material is injected into the mold cavity, the bottom shell is disposed at the upper die, and then the lower die is covered with the upper die, so that the liquid foamable material is expanded and formed into the elastomer between the bottom shell and the cover layer, and meanwhile the bottom shell and the cover layer are combined with the elastomer in the forming mold.

8. The method of claim 7, wherein in the step b) a connection layer is disposed at one of the upper die and the lower die before the lower die is covered with the upper die; while the lower die is covered with the upper die, the bottom shell is combined with the elastomer through the connection layer.

9. The method of claim 8, wherein the connection layer is a plastic film.

10. The method of claim 7, wherein the forming mold further comprises a pressing frame; in the step a) the circumferential area of the cover layer is disposed between the pressing frame and the lower die; while the lower die is covered with the upper die, the upper die is pressed on the pressing frame.

11. The method of claim 10, wherein in the step b) a connection layer is disposed at one of the upper die and the lower die before the lower die is covered with the upper die; while the lower die is covered with the upper die, the connection layer is disposed between the pressing frame and one of the lower die and the upper die, and the bottom shell is combined with the elastomer through the connection layer.

12. The method of claim 11, wherein the connection layer is a plastic film.
